(19) United States
(12) Patent Application Publication
(10) Pub. No.: US 2003/0080561 A1
(43) Pub. Date: May 1, 2003

(54) Underground couplings

(76) Inventor: Ronald Allen Ezra Martin Ron Martin, Angier, NC (US)

Correspondence Address: Ronald Allen Ezra Martin, 1660 Oak Grove Church Road, Angier, NC, 27501, US

(21) Appl. No.: 10/264,175

(22) Filed: Oct. 3, 2002

Related U.S. Application Data
(60) Provisional application No. 60/327,391, filed on Oct. 4, 2001.

(51) Int. Cl. F16L 17/00

(52) U.S. Cl. 285/340; 285/369; 285/919

(57) ABSTRACT

This invention is a new and improved PVC conduit coupling (FIG. 1) designed specifically for the use of connecting PVC conduits together under roadways, asphalt, concrete and underground. A long, cylindrical, sleeve-type embodiment that has a greater Glue Surface Area (1) and a stop ring (4). This new invention utilizes the greater Glue Surface Area (1) that keeps conduits from pulling apart, giving the installer and the owner assurance of conduit continuity.

### FEDERALLY SPONSORED RESEARCH

Not Applicable

### SEQUENCE LISTING OR PROGRAM

Not Applicable

### BACKGROUND

1. Field of Invention

This invention is an electrical conduit fitting designed for plastic PVC conduit.

2. Description of Prior Art

Electrical plastic PVC conduit is often used for underground electrical wiring. There is a huge problem with the material available; that is, the conduit couplings do not have adequate Glue Surface Area. Existing couplings have less than half of the Glue Surface Area than the bell end or coupling end of a ten foot stick of conduit. When the conduit is hit by another underground contractor, the bell ends hold and the short coupling pulls apart because of inadequate Glue Surface Area.

A ten foot stick of ¾ inch conduit has 2.1 inches of Glue Surface Area length on the bell end. But the couplings from all the large manufacturers such as Carlon, Southern Pipe Co., Cantex, etc. all have less than ¾ inches of Glue Surface Area length.

### OBJECTS and ADVANTAGES

The object of this invention is to have a connecting device to connect two straight (non bell) ends of conduit together and retain the holding power that a bell end and a straight piece glued together have. This gives you assurance that your conduit will stay together under roadway and concrete slabs. The advantage of this invention is that we could use factory pre-bent 90° or 45° without fear of the coupling pulling apart.

### SUMMARY

In accordance with the present invention, an underground PVC coupling is a cylindrical PVC sleeve with a center stop to prevent overslide with the same or more Glue Surface Area as the bell end of trade size conduits. Used to connect conduits together underground to assure continuity.

### DRAWINGS

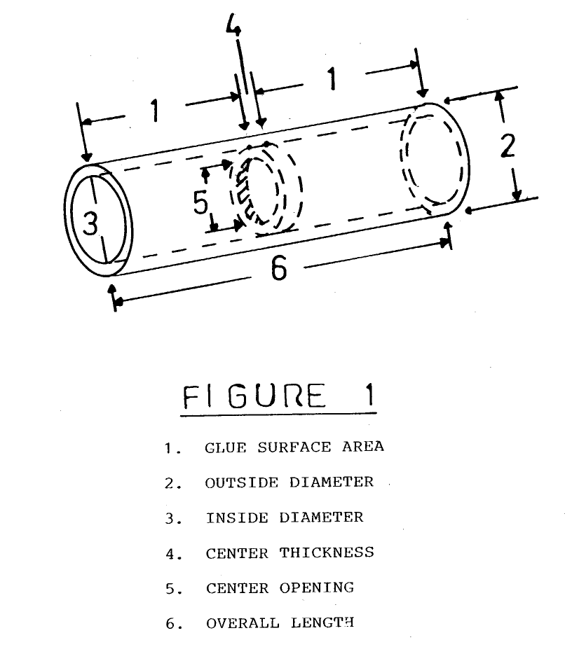

The drawing FIG. 1 shows all the necessary dimensions used to describe underground couplings. The main thing that will be referred to mostly is #1 Glue Surface Area.

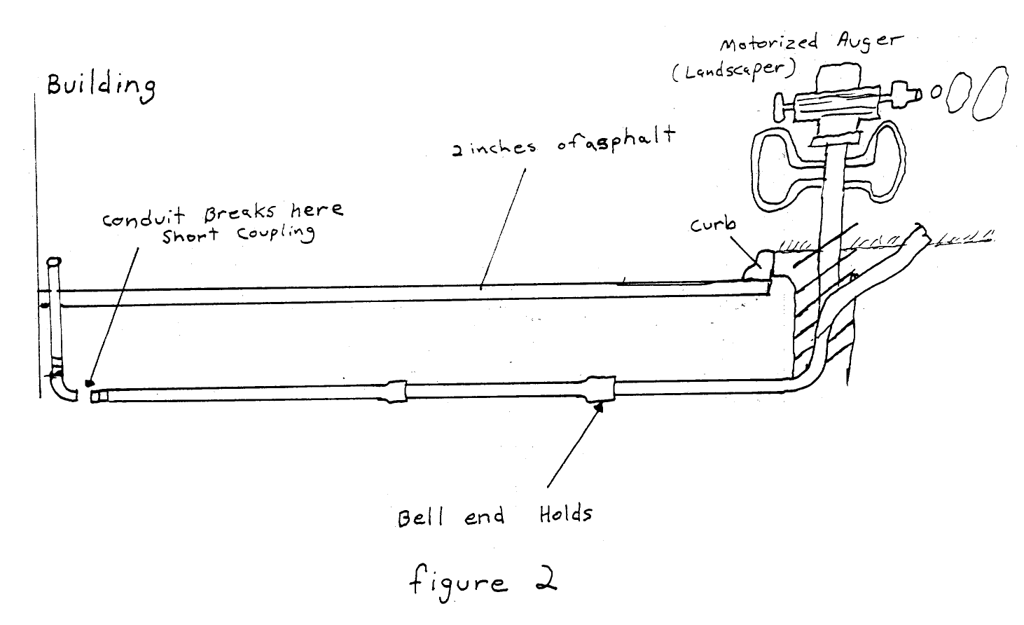

The drawing FIG. 2 simply shows a typical pull-apart scenario.

### DETAILED DESCRIPTION

A preferred embodiment of the present invention is shown in FIG. 1. The coupling is a cylindrical sleeve that the conduit is glued and then slid into the inside of the coupling connecting two pieces of conduit together. It consists of one piece but having a center stop ring not smaller in the center opening (#5 in FIG. 1) than the trade size conduit. Underground couplings utilize 170% to 230% of Glue Surface Area (#1 in FIG. 1) than the normal standard coupling or 100% of the Glue Surface Area of a bell end of a ten foot piece of PVC conduit on a detached embodiment and can be attached with glue.

Advantages

It is clear that the advantage of this invention is the added Glue Surface Area to keep very good continuity to underground wiring and PVC conduit systems.

Ramifications and Conclusion

The ramifications of this invention can be easily seen in FIG. 2 in a typical pull-apart scenario. Usually when this happens, the point that the conduit is broken at is under asphalt or concrete. This invention will aid in the prevention of breakage down the conduit. When another contractor (such as the landscape contractor) digs up your conduit, it will break at the point of hit, making repairs easy and the responsibility of the repairs clear.

I claim:

1. In a cylindrical sleeve-type embodiment of all standard trade sizes thereof, and the new longer, greater Glue Surface Area wherein said expanding the Glue Surface Area from 170% to 230% of existing standard couplings.

2. The cylindrical embodiment of claim 1 wherein said for the use under roadways, asphalt, concrete and underground.

3, In a cylindrical sleeve-type embodiment of all standard trade sizes thereof, and the Glue Surface Area wherein said is the same or greater than the bell end of a ten foot piece of PVC conduit (ridged non-metallic) on a detached unit.

4. The cylindrical embodiment of claim 3 wherein said for the use under roadway, asphalt, concrete and underground.
